(19) United States
(12) Patent Application Publication
(10) Pub. No.: US 2012/0325980 A1
(43) Pub. Date: Dec. 27, 2012

(54) SYSTEM AND METHOD FOR COMMUNICATING WITH A WAYSIDE DEVICE

(76) Inventors: Joseph Forrest Noffsinger, Grain Valley, MO (US); Glenn Shaffer, Erie, PA (US); Jeffrey Fries, Melbourne, FL (US); Jared Cooper, Melbourne, FL (US)

(21) Appl. No.: 13/168,482

(22) Filed: Jun. 24, 2011

(51) Int. Cl. H04L 12/56

(52) U.S. Cl. 246/169 R; 246/219; 246/473.1; 246/167 R; 370/401

(57) ABSTRACT

A communication system includes an electronic component located at a wayside device positioned along a route of a rail vehicle and a router transceiver unit operably coupled to the electronic component. The router transceiver unit is conductively coupled to a power supply conductor that supplies electric current to power at least one of the electronic component of the wayside device or an electronic apparatus other than the electronic component. The router transceiver unit is configured to communicate network data with a remote location through the power supply conductor.

### FIELD OF THE INVENTION

One or more embodiments of the presently described inventive subject matter generally relate to data communications, such as data communications with and/or between wayside devices located along a vehicle route, such as a track of a rail vehicle consist.

### BACKGROUND OF THE INVENTION

Certain vehicle routes (e.g., railroad tracks) are outfitted with wayside signal devices. Such devices are controllable to provide information to vehicles and vehicle operators traveling along the route. For example, a typical traffic control signal device might be controllable to switch between an illuminated green light, an illuminated yellow light, and an illuminated red light, which might be understood in the traffic system to mean “ok to proceed,” “prepare to stop,” and “stop,” respectively, for example.

In a first category of wayside signal device, each device is a mechanical, non-electrical signal device, which does not electrically communicate with other devices. For example, it may be the case that the mechanical signal device is mechanically interfaced with a proximate rail switching device, so that if the switching device is in a first position, the signal device is automatically mechanically controlled to be in a first state (such as a signal arm being moved to a raised position), and if the switching device is in a second, different position, the signal device is automatically mechanically controlled to be in a second, different state (such as the signal arm being moved to a lowered position).

In another category of wayside signal device, each device is provided with electrical power, but is otherwise “self contained” and does not communicate with a centralized traffic control center or other remote location. For example, it may be the case that the wayside signal device is responsive to the current position of a local rail switching device, so that if the switching device is in a first position, a first signal light portion of the wayside signal device is automatically illuminated, and if the switching device is in a second, different position, a second light portion of the wayside signal device is illuminated.

In another category of wayside signal device, each device is provided with electrical power, and is able to communicate with a centralized traffic control center or other remote location, for control and other purposes. For example, it may be the case that an entity at the remote location is able to transmit control signals to the wayside signal device for switching between different signal aspects, and/or the wayside signal device may provide information to the remote location about its current or present signal aspect (meaning the signal aspect presented by the wayside signal device at the time the information is generated and communicated). A copper cable may be provided to transmit such control signals and information, but this is expensive due to the long distances involved and the work required for installation and maintenance.

As modern traffic systems increase in complexity, it may be desired to increase the degree and extent to which it is possible to communicate with wayside signal devices. However, for mechanical signal devices and “self-contained”/local electrical wayside signal devices, it is not possible to communicate with the device at all, and for other signal devices, existing communication pathways (e.g., copper cables) may be insufficient. Additionally, it is very expensive to individually outfit wayside devices with data radios or other wireless transmission equipment, fiber optic terminals, etc.

A need exists for a communication system and method that permits communication of wayside devices with reduced cost relative to other known systems and methods.

### BRIEF DESCRIPTION OF THE INVENTION

In one embodiment, a communication system is provided. The system includes an electronic component located at a wayside device positioned along a route of a rail vehicle and a router transceiver unit operably coupled to the electronic component. The router transceiver unit is conductively coupled to a power supply conductor that supplies electric current to power at least one of the electronic component of the wayside device or an electronic apparatus other than the electronic component. The router transceiver unit is configured to communicate network data with a remote location through the power supply conductor.

In another embodiment, a method of communicating network data is provided. The method includes communicatively coupling a router transceiver unit with an electronic component located at a wayside device positioned along a route of a rail vehicle and conductively coupling the router transceiver unit to a power supply conductor used to supply electric current to power at least one of the electronic component of the wayside device or an electronic apparatus other than the electronic component. The router transceiver unit is configured to communicate network data with a remote location through the power supply conductor.

In another embodiment, a communication system is provided. The system includes plural electronic components respectively located at a plurality of wayside devices positioned at different locations along a route of a rail vehicle and plural router transceiver units respectively operably coupled to the electronic components. The router transceiver units are conductively coupled to one or more power supply conductors that supply electric current to power at least one of the electronic components of the wayside devices or one or more electronic apparatuses other than the electronic components. The system also includes a common node conductively coupled with the router transceiver units by the one or more power supply conductors. The common node is configured to communicate network data with the router transceiver units through the one or more power supply conductors.

In another embodiment, a communication method is provided. The method includes, at a wayside device positioned along a route of a rail vehicle, automatically generating first data relating to operation of the wayside device and converting the first data into modulated network data for transmission over a power supply conductor that supplies electric current for powering at least one of an electronic component of the wayside device or an electronic apparatus other than the electronic component. The method also includes transmitting the modulated network data over the power supply conductor to a remote location.

In another embodiment, a communication method is provided. The method includes, over one or more power supply conductors that supply electric current for electrically powering at least one of plural wayside devices positioned along one or more rail vehicle routes or an electrical apparatus other than the plural wayside devices, respectively receiving plural first signals from the plural wayside devices, each first signal including respective network data. The method also includes demodulating the plural first signals into respective second signals, the second signals comprising at least the respective network data and converting the second signals into respective third signals for transmission over an Ethernet line, the Internet, or other network. The method further includes transmitting the third signals over the Ethernet line, the Internet, or the other network to one or more remote locations.

In another embodiment, a communication system is provided. The system includes a router transceiver unit comprising an adapter and a communication unit operably coupled to the communication unit. The adapter is configured to be operably coupled with an electronic component of a wayside device, for receiving first data from the electronic component. The communication unit is configured to be conductively coupled to a power supply conductor that supplies electric current to power the electronic component or an electronic apparatus other than the electronic component, and wherein the communication unit is further configured to convert the first data to modulated network data and to transmit the modulated network data over the power supply conductor to a remote location.

In another embodiment, a method for communicating with a wayside signal device is provided. The method includes transceiving network data at a wayside signal device located adjacent to a route of a rail vehicle, where the network data is transceived at the wayside signal device over a pre-existing electrical power line used to provide the wayside signal device with electrical power and/or that lies proximate to the wayside signal device.

In another embodiment, another method for communicating with a wayside signal device is provided. The method includes receiving first high bandwidth network data at a wayside signal device located adjacent to a route of a rail vehicle. The network data is received at the wayside signal device over a pre-existing electrical power line that provides the wayside signal device with electrical power. The method also includes controlling the wayside signal device based on the first high bandwidth network data.

In another embodiment, another communication system is provided. The system includes a router transceiver unit operably coupled to an electronic component located at a wayside signal device positioned adjacent to a route of a rail vehicle. The router transceiver unit is electrically coupled to a pre-existing electrical power line used to provide electrical power to the wayside signal device and/or that lies proximate to the wayside signal device. The router transceiver unit is configured to transmit and/or receive network data over the electrical power line. The network data originates at a location remote to the wayside signal device and is received at the wayside signal device and/or the network data comprising information generated by the electronic component and transmitted to a remote location.

In another embodiment, another communication system is provided. The system includes a computer network in a rail transit system. The computer network comprises a respective electronic component positioned at each of at least two of a plurality of wayside signal devices. Each wayside signal device is located adjacent to a route of a rail vehicle. A pre-existing electrical power grid supplies electrical power to the at least two of the plurality of wayside signal devices. The electronic components are configured to communicate by transmitting network data over the electrical power grid. The network data originates at one of the electronic components and being addressed to another of the electronic components or to another component at a remote location.

### BRIEF DESCRIPTION OF THE DRAWINGS

The present invention will be better understood from reading the following description of non-limiting embodiments, with reference to the attached drawings, wherein below:

FIG. 1 illustrates a schematic diagram of one embodiment of a communication system;

FIG. 2 illustrates a schematic diagram of one embodiment of a router transceiver unit shown in FIG. 1;

FIG. 3 is a schematic diagram of one example of how a signal modulator module shown in FIG. 2 could function;

FIG. 4 is a circuit diagram of another embodiment of the router transceiver unit shown in FIG. 1;

FIG. 5 is a flowchart of a method for communicating network data;

FIG. 6 is a schematic diagram of one embodiment of a node that is coupled with a plurality of the router transceiver units and the wayside devices shown in FIG. 1 by a power supply conductor also shown in FIG. 1;

FIG. 7 is a schematic diagram of another embodiment of a node that is coupled with a plurality of the router transceiver units and the wayside devices by a power supply conductor shown in FIG. 1;

FIG. 8 is a schematic diagram of another embodiment of a node that is coupled with a plurality of the router transceiver units and the wayside devices by plural power supply conductors shown in FIG. 1;

FIG. 9 is a schematic diagram of another embodiment of a router transceiver unit;

FIG. 10 is a schematic diagram of another embodiment of a router transceiver unit; and

FIG. 11 is a schematic diagram of another embodiment of a router transceiver unit.

### DETAILED DESCRIPTION OF THE INVENTION

Embodiments of the inventive subject matter described herein generally relate to systems and methods for communicating data with electronic components of wayside devices disposed along a route of a vehicle, such as a rail vehicle or rail vehicle consist. “Consist” refers to a group of vehicles, such as rail vehicles, that are mechanically coupled or linked together to travel on a track that extends along the route of the consist. One or more wayside devices are disposed at or near the route of the rail vehicles. “Wayside device” refers to a mechanically or electrically controllable device that is positioned along a rail vehicle route or other vehicle route. The wayside device can be used to control operations of the route, such as by controlling a switch at an intersection of two or more diverging sections of track, raising or lowering a crossing gate to allow or prevent vehicles and pedestrians from crossing the track, respectively, and the like. Other wayside devices can be used to control or impact operations of the rail vehicles, such as by providing visual signals to operators on the rail vehicles to proceed, slow down, or stop movement of the rail vehicles, providing control signals (e.g., positive train control, or PTC) to the rail vehicles to control tractive operations of the rail vehicles, and the like. Other wayside devices can include sensors that monitor one or more parameters of the route and/or the rail vehicles, such as hot box detectors that monitor axle and/or wheel bearing temperatures of the rail vehicles as the rail vehicles travel along the track. The wayside devices can be coupled with electronic components that control operations of the wayside devices. The above examples of wayside devices are not intended to limit all embodiments of the presently described subject matter. For example, one or more other wayside devices may be used in connection with one or more of the embodiments described herein.

In one embodiment, router transceiver units are operatively coupled with the electronic components of the wayside devices and with a power supply conductor that delivers electric current to the electronic components and/or other electronic apparatuses other than the electronic components. The electric current supplied to the electronic components and/or apparatuses powers the electronic components and/or apparatuses. The router transceiver units communicate (e.g., transmit and/or receive) network data through the power supply conductor. The router transceiver units may communicate the network data at or during the same time when the electronic components or other electronic apparatuses are receiving power from the power supply conductor. For example, the network data may be piggybacked, or transmitted on top of, the current that is supplied through the power supply conductors to power the electronic components and/or apparatuses. Alternatively, the router transceiver units may communicate the network data at times when the electronic components or other electronic apparatuses are not receiving power from the power supply conductor.

“Network data” refers to data that is packaged in packet form as data packets. Each data packet can include the network address of a recipient of the data packet. The network data may be transmission control protocol/Internet protocol (TCP/IP) formatted data. Alternatively, another communication protocol may be used. The network data may be transmitted over a pre-existing power supply conductor that previously was coupled with the electronic components and/or apparatuses. For example, the power supply conductors used to transmit the network data may include one or more separate or interconnected buried or exposed power distribution cables, aerial pole lines, and/or cables that are conductively coupled with a commercial power grid.

Several electronic components of the wayside devices disposed at different locations may be conductively interconnected by one or more power supply conductors in a computer network. The router transceiver units of the electronic components may communicate network data with each other using the power supply conductors. In one embodiment, the network is an Ethernet computer network. One or more of the electronic components may be network enabled devices (e.g., Ethernet devices) that generate or create network data for communication to the routher transceiver units. Alternatively, one or more of the electronic components may be non-network enabled devices (e.g., analog devices) that generate or create non-network data (e.g., analog data) for communication to the router transceiver units. The router transceiver units may convert the non-network data (e.g., analog data) to network data and transmit the network data through the power supply conductor.

The electronic components may automatically obtain or create data that is communicated by the router transceiver units as network data through the power supply conductor. For example, the electronic components may periodically obtain or create data and/or may obtain or create the data after detection of an event (e.g., a measured characteristic exceeds or falls below a threshold). The data obtained or created by the electronic components may relate to operation of the associated wayside devices. For example, the data can include sensor data, diagnostic information, alarm information, indication of a status (e.g., on, off, color of a light illuminated by the wayside device, and the like) of the wayside device, indication of a condition (e.g., in need of repair or maintenance, not in need of repair or maintenance, broken, and the like), or other information.

One or more of the electronic components can include one or more sensors that obtain diagnostic information and/or alarm information related to an associated wayside device, the track, and/or the rail vehicle. The router transceiver units can transmit the diagnostic information and/or alarm information with other router transceiver units and/or to a common node in the network. The common node can be a centralized or distributed monitoring station that receives the diagnostic information, alarm information, and/or other information from the electronic components in the network to monitor operations in the network.

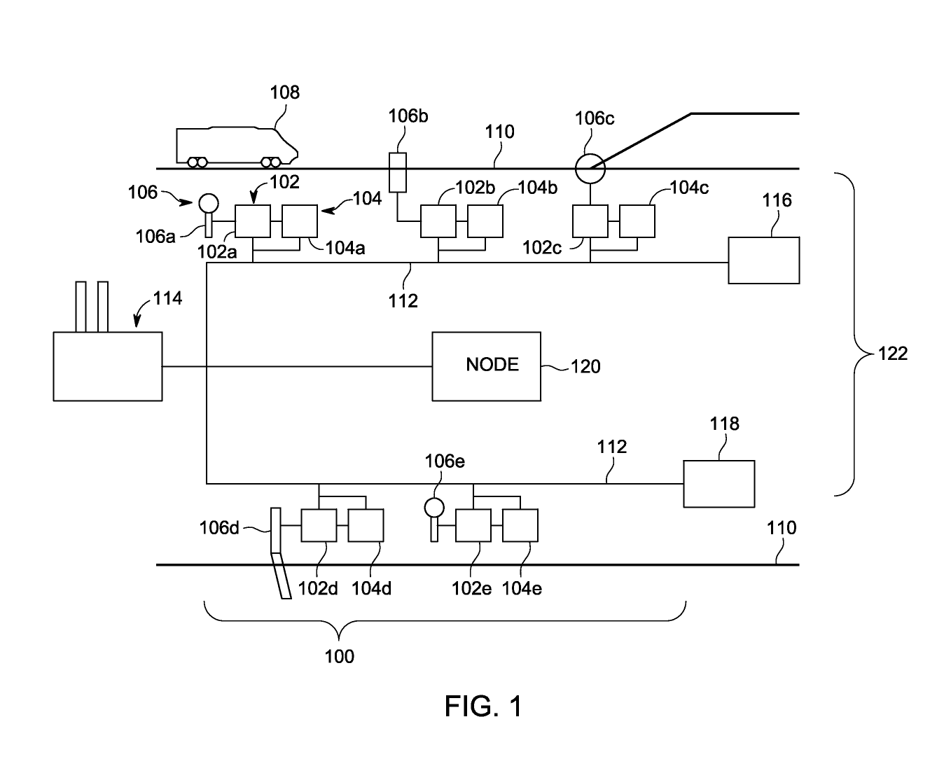

FIG. 1 is a schematic diagram of one embodiment of a communication system 100. The system 100 includes several electronic components 102 and several router transceiver units 104 communicatively coupled with the electronic components 102. “Communicatively coupled” includes connecting an electronic component 102 with a router transceiver unit 104 by one or more wired and/or wireless communication links such that data can be communicated between the electronic component 102 and the router transceiver unit 104. The electronic components 102 are generally referred to by the reference number 102 and are individually referred to by the reference numbers 102a, 102b, 102c, and so on. The router transceiver units 104 are generally referred to by the reference number 104 and are individually referred to by the reference numbers 104a, 104b, 104c, and so on.

The electronic components 102 are operatively coupled with wayside devices 106. “Operably coupled” or “operatively coupled” can include connecting two or more components with one or more mechanical, wired, and/or wireless connections. For example, an electronic component 102 can be operably or operatively coupled with a wayside device 106 by one or more mechanical, wired, and/or wireless connections such that the electronic component 102 can control one or more operations of the wayside device 106 and/or communicate data with the wayside device 106. The wayside devices 106 are generally referred to by the reference number 106 and are individually referred to by the reference numbers 106a, 106b, 106c, and so on. The wayside devices 106 are positioned along a route 110 of a rail vehicle 108, such as a train, locomotive, and/or rail vehicle consist. Alternatively, the wayside devices 106 may be positioned along a route of another type of vehicle or vehicle consist. In the illustrated embodiment, the wayside devices 106 are disposed alongside a track that defines the route 110 of the rail vehicle 108. The wayside devices 106 may be located within the right of way associated with the route 110, such as by being disposed within a predetermined distance from the route 110. For example, the wayside devices 106 may be no greater than sixty feet from the route 110. Alternatively, the wayside devices 106 may be a different distance from the route 110.

The wayside devices 106 and the electronic components 102 perform one or more operations in connection with the rail vehicle 108 and/or route 110. For example, the wayside devices 106a, 106e may include rail signal devices that illuminate to convey information or directions to an operator of the rail vehicle 108. The wayside devices 106a, 106e can include lamps that are illuminated in different colors, such as green, yellow, and/or red to indicate “ok to proceed,” “prepare to stop,” and “stop,” respectively, to the operator. The wayside device 106b may include a sensor that detects a condition of the rail vehicle 108 and/or the route 110. For example, the wayside device 106b may include a hot box detector that monitors thermal energy or temperature of wheels, axles, bearings, and the like, of the rail vehicle 108. As another example, the wayside device 106b may include another type of defect detector that monitors the rail vehicle 108, such as a dragging equipment detector, a wheel impact detector, a sliding wheel detector, a high car detector, a shifted load detector, a weighing in motion detector, a wide load detector, and the like. The wayside device 106b may monitor the route 110, such as by including a sensor that detects a position or state of a switch between diverging sections of the route 110. In another embodiment, the wayside device 106b can represent a PTC device, such as a device that transmits signals to speed control units disposed on board the rail vehicle 108 to control the speed of the rail vehicle 108. The wayside device 106b may transmit the signals wirelessly or through rails of the track to the rail vehicle 108.

The wayside device 106c may represent a track switch disposed at an intersection of diverging sections of the route 110. For example, the wayside device 106c may move a portion of the track between plural positions in order to change the direction that the route 110 follows. The wayside device 106d can represent a road crossing warning system, such as a gate that raises or lowers to allow or permit, respectively, vehicles and pedestrians to cross the route 110. The wayside devices 106 described herein and the number of wayside devices 106 are provided as examples. One or more other wayside devices 106 and/or a different number of one or more of the wayside devices 106 may be used.

The electronic components 102 can control one or more operations of the wayside device 106 and/or communicate data with the wayside device 106. The electronic components 102 may include logic-based devices that perform the operations and/or direct the wayside device 106 to perform the operations. Examples of such logic-based devices include computer processors, controllers, hard-wired logic, application specific integrated circuits (ASICs), and the like. One or more of the electronic components 102 may generate diagnostic information and/or alarm information related to the rail vehicle 108 and/or the route 110 (e.g., the track). For example, the electronic component 102b that is coupled with the wayside device 106b that can represent a defect sensor or detector may generate information related to one or more defects of the rail vehicle 108 or route 110 (e.g., the track) as diagnostic information. If one or more of the defects that is detected by the wayside device 106b indicates an alarm condition (e.g., a bearing temperature that exceeds a threshold), then the electronic component 102b can generate alarm information that represents the alarm condition. In another embodiment, the electronic components 102 may receive the diagnostic information from the wayside devices 106 and perform the alarming analysis (e.g., processing of the diagnostic information to determine if an alarm condition exists) on the received diagnostic information.

In the illustrated embodiment, the electronic components 102 are conductively coupled with power supply conductors 112 that supply electric current to the electronic components 102 to power the electronic components 102 and/or the wayside devices 106. The power supply conductors 112 may represent one or more buried or exposed power distribution cables, aerial pole lines, cables conductively coupled with a commercial power grid 114, and the like. Alternatively, the power supply conductors 112 may represent one or more conductors that interconnect a plurality of the router transceiver units 104 in a serial (e.g., daisy chain) or parallel manner to form a network. The commercial power grid 114 may include one or more networks of power supply conductors 112 that deliver electric current to customers (e.g., businesses and/or homes) in exchange for a fee. Alternatively, one or more of the electronic components 102 may not be coupled with the power supply conductors 112. For example, the electronic components 102 may receive electric power from another source, such as a battery, solar panel, wind turbine, and the like. The power supply conductors 112 may supply electric current to one or more of the electronic components 102 and/or one or more other electronic apparatuses 116, 118. The electronic apparatuses 116, 118 can represent a device that is powered by the electric current received by the power supply conductors 112 but that does not perform one or more of the functions of the wayside devices 106. In one embodiment, the power supply conductors 112 may include one or more conductors that supply power to the rail vehicles 108 and/or other conductors disposed along the route 110. For example, in one embodiment, the power supply conductors 112 may be conductors other than a running rail of a track on which the rail vehicle 108 travels, a powered rail from which the rail vehicle 108 receives (e.g., a powered third rail that supplies electric power to a shoe of the rail vehicle 108), and/or an overhead catenary that supplies power to the rail vehicle 108. Alternatively, the power supply conductors 112 may not include the conductors that supply power to the rail vehicles 108.

The router transceiver units 104 are communicatively coupled with the electronic components 102 to communicate network data to and/or from the electronic components 102. Network data can include packetized data, such as data that is arranged into a sequence of packets having headers with an address of the intended recipient of the packets, locations of the packets relative to each other (e.g., for forming the packets back into the original message), and the like. The router transceiver units 104 can communicate the network data between the electronic components 102. For example, the router transceiver units 104 can communicate statuses of various wayside devices 106 coupled with the electronic components 102 to the router transceiver units 104 coupled with other wayside devices 106 and electronic components 102. The statuses may indicate a position of a switch, crossing gate, light, and the like. Alternatively, the router transceiver units 104 can communicate diagnostic information and/or alarm information from one electronic component 102 to another electronic component 102.

The router transceiver units 104 are communicatively coupled with the power supply conductors 112 and communicate the network data through the power supply conductors 112. In one embodiment, the router transceiver units 104 are coupled with pre-existing power supply conductors 112 that already are conductively coupled with the electronic components 102 and/or the wayside devices 106. For example, the router transceiver units 104 may be retrofitted to the electronic components 102 and/or the wayside devices 106 by coupling the router transceiver units 104 to the power supply conductors 112 and the electronic components 102 and/or wayside devices 106. Retrofitting the router transceiver units 104 to existing power supply conductors 112 can add the functionality of communicating network data with the electronic components 104 and/or wayside devices 106 without adding more conductive pathways (e.g., wires, cables, and the like) between the electronic components 104 and/or wayside devices 106.

The router transceiver units 104 communicate network data with a remote location. A remote location can include the router transceiver unit 104 of another electronic component 102 and/or wayside device 106. By “remote,” it is meant that a transmitter of the network data (e.g., a first network transceiver unit 104) and a receiver of the network data (e.g., a second network transceiver unit 104 or other electronic device) are at physically separate locations that are not near or immediately close to each other. The remote location can be disposed several feet or meters apart from the router transceiver unit 104, several miles or kilometers apart, or a greater distance apart.

In the illustrated embodiment, the router transceiver units 104 are conductively coupled with a node 120 by the power supply conductors 112. The node 120 can represent one or more computing devices (e.g., one or more computers, processors, servers, and the like) that communicate network data with the router transceiver units 104 via the power supply conductors 112. The node 120 may be a common node to several of the router transceiver units 104, such as a central node in a computer network 122 formed by the router transceiver units 104, the electronic components 102, and the power supply conductors 112. Alternatively, the node 120 may be a common node to several router transceiver units 104 in a distributed or non-centralized computer network. The network formed by the router transceiver units 104, the electronic components 102, and the power supply conductors 112 may be an Ethernet network, such as a Local Area Network (LAN). The node 120 may be located at a central dispatch office of a railroad or at a control tower of a rail yard. Alternatively, the node 120 may be at another location. The node 120 may receive the diagnostic information and/or the alarm information received from the router transceiver units 104 to monitor diagnostics and/or alarms related to conditions of the rail vehicle 108 and/or route 110.

In one embodiment, the router transceiver units 104 are communicatively coupled with each other in the network 122 by the power supply conductors 112. The router transceiver units 104 may communicate network data between each other through the power supply conductors 112. For example, the router transceiver units 104 may communicate status information, diagnostic information, alarm information, condition information of wayside devices 106, and/or other information related to the wayside devices 106 with other router transceiver units 104. The router transceiver units 104 may receive the information related to the wayside devices 106 to coordinate actions, conditions, or states of the wayside devices 106. For example, with respect to several wayside devices 106 that illuminate different colors (e.g., red, yellow, and green) to notify operators of the rail vehicle 108 to change movement of the rail vehicle 108, the router transceiver units 104 of the wayside devices 106 can communicate the current status (e.g., illuminated color) of the corresponding wayside devices 106 among the router transceiver units 104 through the network 122 to ensure that the correct wayside devices 106 are displaying the correct status or color. Other information may be communicated between the wayside devices 106 through the power supply conductors 112. For example, a first wayside device 106 may detect occupancy of a section of track by a rail vehicle 108 using an electronic track circuit that is shunted when train wheel axles short a signal placed across the rails of the track. The occupancy of the section of the track may be communicated from the first wayside device 106 to one or more other wayside devices 106 by the router transceiver units 104 and through the power supply conductors 112. In another example, a selection of a route taken by the rail vehicle 108 at a switch may be detected by a first wayside device 106 and communicated to one or more other wayside devices 106 by the router transceiver units 104 and through the power supply conductors 112. Another example includes a failure condition of a wayside device 106 (e.g., a light out condition at a rail signal device). The wayside device 106 in the failure condition may communicate the failure condition to other wayside devices 106 using the router transceiver units 104 and through the power supply conductors 112. The wayside devices 106 that receive the failure condition may change their own status in response thereto (e.g., change their light color in response to the light of a previous wayside device 106 being out).

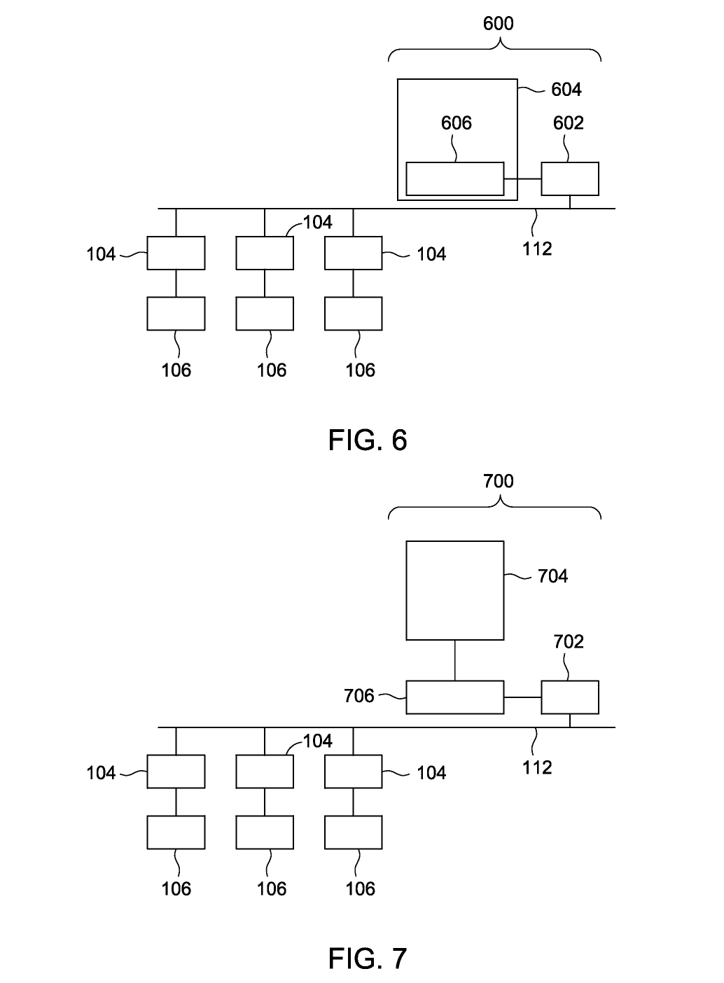

FIG. 6 is a schematic diagram of one embodiment of a node 600 that is coupled with a plurality of the router transceiver units 104 and the wayside devices 106 by a power supply conductor 112. The node 600 may represent the node 120 shown in FIG. 1. The muter transceiver units 104 and the wayside devices 106 may be remote from the node 600. For example, the router transceiver units 104 and the wayside devices 106 may be several miles (e.g., 5, 10, 20, or 50 miles or more) apart from the node 600.

The node 600 includes a router transceiver unit 602 that communicates the network data with the router transceiver units 104. The router transceiver unit 602 may be similar to one or more of the router transceiver units 104. For example, the router transceiver unit 602 can receive and/or transmit network data with the router transceiver units 104 of the wayside devices 106 through the power supply conductor 112. The node 600 can include a physical structure or building 604 used by one or more human persons, such as a dispatch or other office, a signaling bungalow or shack, or other structure. The node 600 includes a computing device 606, such as a computer, server, or other device capable of interacting with human persons to receive input and/or provide output to the persons. The computing device 606 can be disposed within the building 604 and may include one or more processors and/or computer readable storage media, such as a computer hard drive, that operate on the network data received by the router transceiver unit 602 and/or generate network data for transmission by the router transceiver unit 602. The computing device 606 may be used by persons to monitor the statuses, measurements obtained by, and other information relevant to the wayside devices 106 and communicated to the node 600 as network data by the router transceiver units 104. Although not shown in FIG. 6, the router transceiver units 104 can be coupled with electronic components 102 (shown in FIG. 1) of the wayside devices 106, as described above.

FIG. 7 is a schematic diagram of another embodiment of a node 700 that is coupled with a plurality of the router transceiver units 104 and the wayside devices 106 by a power supply conductor 112. The node 700 may represent the node 120 shown in FIG. 1. The router transceiver units 104 and the wayside devices 106 may be remote from the node 700. For example, the router transceiver units 104 and the wayside devices 106 may be several miles (e.g., 5, 10, 20, or 50 miles or more) apart from the node 700.

The node 700 includes a router transceiver unit 702 that may be similar to the router transceiver unit 602 (shown in FIG. 6) of the node 600 (shown in FIG. 6). For example, the router transceiver unit 702 may communicate network data with the router transceiver units 104 through the power supply conductor 112. Although not shown in FIG. 7, the router transceiver units 104 can be coupled with electronic components 102 (shown in FIG. 1) of the wayside devices 106, as described above.

The node 700 can include a physical structure or building 704 that is similar to the building 604 (shown in FIG. 6) of the node 600 (shown in FIG. 6). For example, the building 704 may be used by one or more human persons to monitor the statuses, measurements obtained by, and other information relevant to the wayside devices 106 and communicated to the node 700 as network data by the router transceiver units 104. Although not shown in FIG. 7, the node 700 can include a computing device, such as the computing device 606 shown in FIG. 6, to allow the persons to interact with and/or monitor the network data transmitted to and/or received from the router transceiver units 104.

In the illustrated embodiment, the building 704 represents a remote office. For example, the building 704 may represent one or more structures that are disposed at least several miles away from the router transceiver unit 702 and/or the power supply conductor 112. The router transceiver unit 702 can communicate with the building 704 via a network connection 706. The network connection 706 can represent one or more computing devices, communication lines, and the like, that are communicatively coupled with one another in a network or a portion of a network. For example, the network connection 706 may represent one or more Ethernet lines (e.g., conductive pathways used to communicate network data), routers, modems, computers, servers, and/or other devices that are coupled together in a packet-switched network, such as the Internet, an internet, a Wide Area Network (WAN), a Local Area Network (LAN), and the like. The router transceiver unit 702 communicates the network data with the building 704 through the network connection 706 such that the router transceiver unit 702 does not need to be directly coupled with and/or located close to the building 704. In one embodiment, the network connection 706 can include one or more wireless connections through which the network data is communicated.

In one embodiment, the router transceiver unit 702 receives electrical signals (e.g., first signals) from a plurality of the wayside devices 106 (e.g., as transmitted by the router transceiver units 104) through the power supply conductor 112. The electrical signals may be transmitted and received over the power supply conductor 112 as modulated network data. The router transceiver unit 702 may demodulate the received electrical signals into demodulated electrical signals (e.g., second signals) that include the network data. The router transceiver unit 702 may convert the demodulated electrical signals into another type of electrical signals (e.g., third signals) that are formatted to be transmitted to the building 704 through the network connection 706.

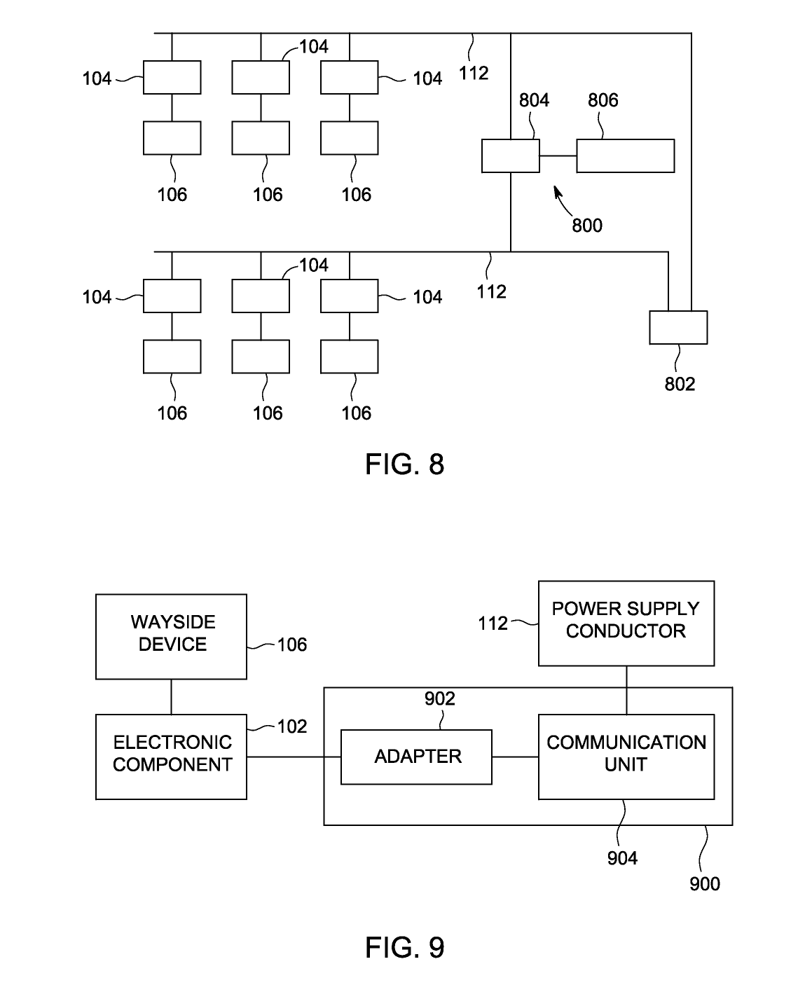

FIG. 8 is a schematic diagram of another embodiment of a node 800 that is coupled with a plurality of the router transceiver units 104 and the wayside devices 106 by plural power supply conductors 112. The node 800 may represent the node 120 shown in FIG. 1. The router transceiver units 104 and the wayside devices 106 may be remote from the node 800. For example, the router transceiver units 104 and the wayside devices 106 may be several miles (e.g., 5, 10, 20, or 50 miles or more) apart from the node 800.

As shown in FIG. 8, plural power supply conductors 112 conductively couple the node 800 with the router transceiver units 104. The power supply conductors 112 may be separate and distinct from each other such that electric current and/or network data that is conveyed through a first power supply conductor 112 is not conveyed through a different, second power supply conductor 112. The power supply conductors 112 may be part of a commercial power grid, such as the power grid 114 shown in FIG. 1. For example, the power supply conductors 112 may extend from a power sub-station 802 of the power grid 114 to the router transceiver units 104 and the wayside devices 106. The power sub-station 802 can supply electric current to the router transceiver units 104 and/or the wayside devices 106 to power the router transceiver units 104 and/or the wayside devices 106. The node 800 also is coupled with the power supply conductors 112 to communicate network data with the router transceiver units 104 through the same power supply conductors 112. Although not shown in FIG. 8, the router transceiver units 104 can be coupled with electronic components 102 (shown in FIG. 1) of the wayside devices 106, as described above.

The node 800 may be similar to the node 600 and/or the node 700 shown in FIGS. 6 and 7. For example, the node 800 may include a router transceiver unit 804 that is similar to the router transceiver unit 602 and/or 702 (shown in FIGS. 6 and 7). The node 800 can include a structure or building 806, such as the building 604 and/or the building 704 (shown in FIGS. 6 and 7). In one embodiment, the node 800 can include a network connection that is similar to the network connection 706 (shown in FIG. 7) between the router transceiver unit 802 and the building 804.

In one embodiment, the router transceiver unit 802 receives a plurality of electrical signals (e.g., first signals) from a plurality of the wayside devices 106 (e.g., as transmitted by the router transceiver units 104) through different power supply conductors 112. For example, the router transceiver unit 802 may receive at least one of the first signals over a first power supply conductor 112 and at least a different one of the first signals over a different, second power supply conductor 112.

The router transceiver unit 802 may demodulate the received electrical signals into demodulated electrical signals (e.g., second signals) that include the network data. The router transceiver unit 802 may convert the demodulated electrical signals into another type of electrical signals (e.g., third signals) that are formatted to be transmitted to the building 804 through the network connection 806.

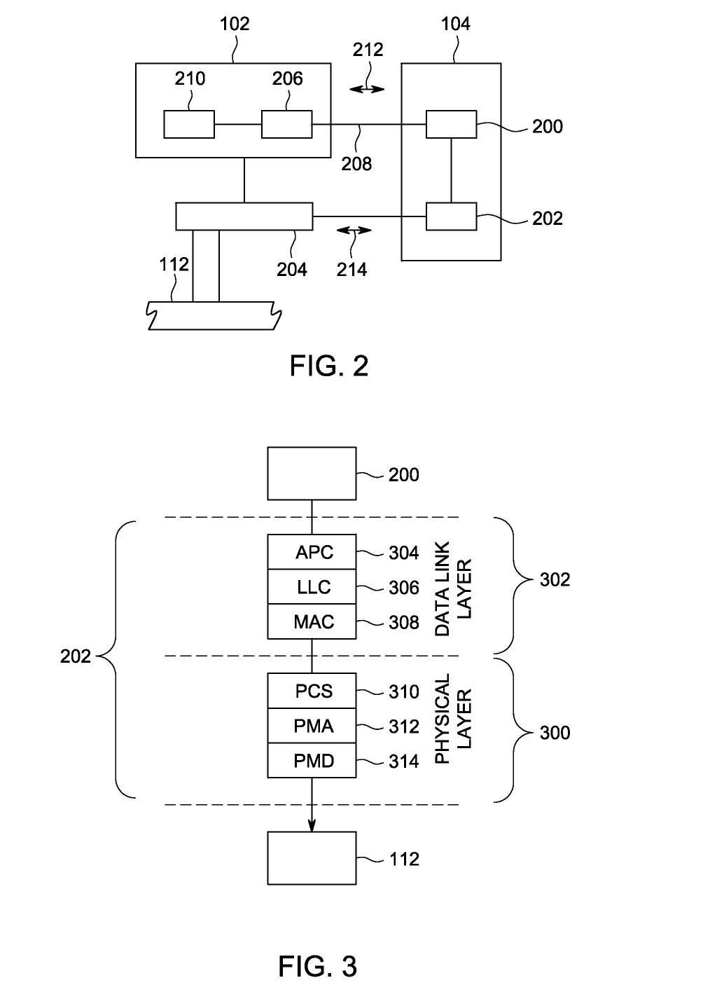

FIG. 2 is a schematic diagram of one embodiment of the router transceiver unit 104. The router transceiver unit 104 includes a network adapter module 200 and a signal modulator module 202. As used herein, the term “module” includes a hardware and/or software system that operates to perform one or more functions. For example, a module may include a computer processor, controller, or other logic-based device that performs operations based on instructions stored on a tangible and non-transitory computer readable storage medium, such as a computer memory. Alternatively, a module may include a hard-wired device that performs operations based on hard-wired logic of the device. The modules shown in the attached figures may represent the hardware that operates based on software or hardwired instructions, the software that directs hardware to perform the operations, or a combination thereof.

The signal modulator module 202 is electrically connected to the network adapter module 200 and to the power supply conductor 112. In the illustrated example, the signal modulator module 202 is electrically connected to the power supply conductor 112 by way of a central terminal board 204. The network adapter module 200 is electrically connected to a network interface unit 206 that is part of and/or communicatively coupled to the electronic component 102. The network adapter module 200 and network interface unit 206 can be electrically interconnected by a network cable 208. For example, if the network adapter module 200 and network interface unit 206 are configured as an Ethernet local area network, the network cable 208 may be a CAT-5E cable. The network interface unit 206 is functionally connected to one or more software or hardware applications 210 in the electronic component 102 that are configured for network communications. In one embodiment, the network interface unit 206, the network cable 208, and the software or hardware applications 210 include standard Ethernet-ready (or other network) components. For example, if the electronic component 102 is a computer unit, the network interface unit 206 may be an Ethernet adapter connected to computer unit for carrying out network communications.

The network adapter module 200 is configured to communicate network data 212 with the network interface unit 206 over the network cable 208. The network adapter module 200 conveys the network data 212 to the signal modulator module 202, which modulates the network data 212 into modulated network data 214 and transmits the modulated network data 214 over the power supply conductor 112. The signal modulator module 202 may receive modulated network data 214 from over the power supply conductor 112 and de-modulates the modulated network data 214 into network data 212, which the signal modulator module 202 then conveys to the network adapter module 200 for transmission to the network interface unit 206. One or both of the network adapter module 200 and the signal modulator module 202 may perform various processing steps on the network data 212 and/or the modulated network data 214 for transmission and reception both over the power supply conductor 112 and/or over the network cable 208 (to the network interface unit 206). Additionally, one or both of the network adapter module 200 and the signal modulator module 202 may perform network data routing functions.

The signal modulator module 202 includes an electrical output (e.g., port, wires) for electrical connection to the power supply conductor 112, and internal circuitry (e.g., electrical and isolation components, microcontroller, software/firmware) for receiving network data 212 from the network adapter module 200, modulating the network data 212 into modulated network data 214, transmitting the modulated network data 214 over the power supply conductor 112, receiving modulated network data 214 over the power supply conductor, de-modulating the modulated network data 214 into network data 212, and communicating the network data 212 to the network adapter module 200. The internal circuitry may be configured to modulate and de-modulate data using schemes such as those utilized in VDSL or VHDSL (very high bitrate digital subscriber line) applications, or in power line digital subscriber line (PDSL) applications.

One example of a suitable modulation scheme is orthogonal frequency-division multiplexing (OFDM). OFDM is a frequency-division multiplexing scheme wherein a large number of closely-spaced orthogonal sub-carriers are used to carry data. The data is divided into several parallel data streams or channels, one for each sub-carrier. Each sub-carrier is modulated with a conventional modulation scheme (such as quadrature amplitude modulation or phase shift keying) at a low symbol rate, maintaining total data rates similar to conventional single-carrier modulation schemes in the same bandwidth. The modulation or communication scheme may involve applying a carrier wave and modulating the carrier wave using digital signals corresponding to the network data 212.

FIG. 3 is a schematic diagram of one example of how the signal modulator module 202 could function, cast in terms of the OSI network model, according to one embodiment of the present invention. In this example, the signal modulator module 202 includes a physical layer 300 and a data link layer 302. The data link layer 302 is divided into three sub-layers. The first sub-layer is an application protocol convergence (APC) layer 304. The APC layer 304 accepts network data 212 (e.g., Ethernet or other network frames) from an upper application layer (e.g., the network adapter module 200) and encapsulates the network data 212 into MAC (medium access control) service data units, which are transferred to a logical link control (LLC) layer 306. The LLC layer 306 is responsible for potential encryption, aggregation, segmentation, automatic repeat-request, and similar functions. The third sub-layer of the data link layer 302 is a MAC layer 308, which schedules channel access. The physical layer 300 is divided into three sub-layers. The first sub-layer is a physical coding sub-layer (PCS) 310, which is responsible for generating PHY (physical layer) headers. The second sub-layer is a physical medium attachment (PMA) layer 312, which is responsible for scrambling and FEC (forward error correction) coding/decoding. The third sub-layer is a physical medium dependent (PMD) layer 314, which is responsible for bit-loading and OFDM modulation. The PMD layer 314 is configured for interfacing with the power supply conductor 112, according to the particular configuration (electrical or otherwise) of the power supply conductor 112. The other sub-layers are medium independent, i.e., do not depend on the configuration of the power supply conductor 112.

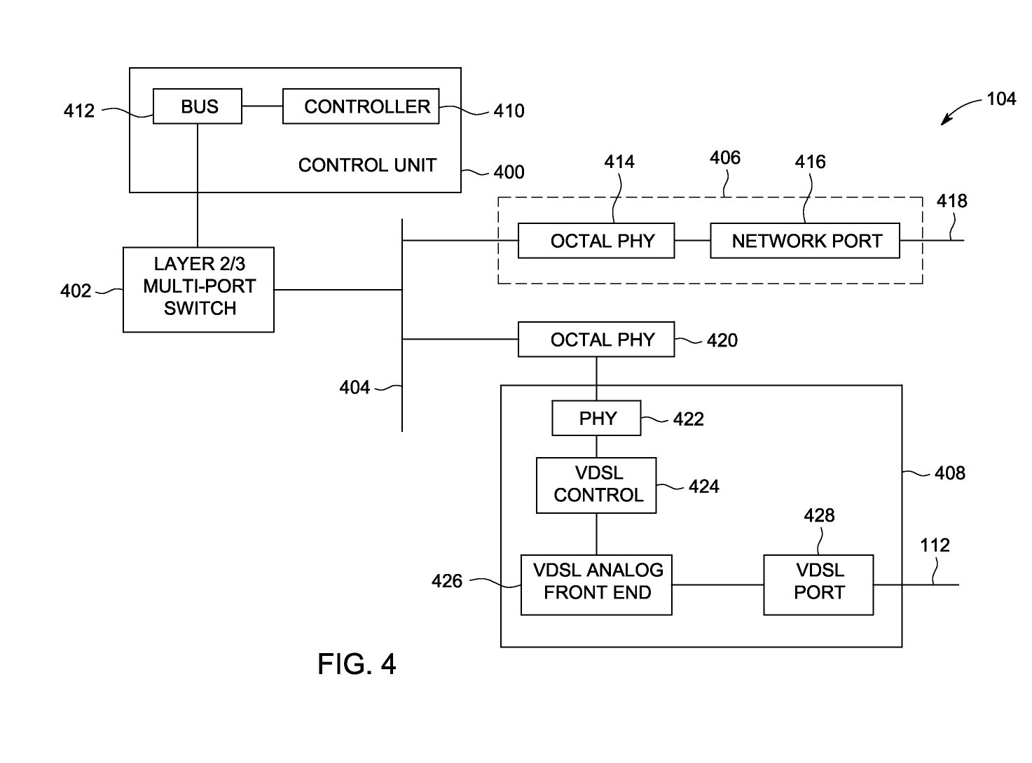

FIG. 4 is a circuit diagram of another embodiment of a router transceiver unit 412. In this embodiment, the router transceiver unit 412 comprises a control unit 400, a switch 402, a main bus 404, a network interface portion 406, and a very high bitrate digital subscriber line (VDSL) module 408. The control unit 400 comprises a controller 410 and a control unit bus 412. The controller 410 is electrically connected to the control unit bus 412 for communicating data over the bus 412. The controller 410 may be a microcontroller or other processor-based unit, including support circuitry for the microcontroller. The switch 402 is a network switching/router module configured to process and route packet data and other data. The switch 402 interfaces the control unit 400 with the main bus 404. The switch 402 may be, for example, a layer 2/3 multi-port switch. The network interface portion 406 is electrically connected to the main bus 404, and comprises an octal PHY (physical layer) portion 414 and a network port portion 416. The network port portion 416 is electrically connected to the octal PHY portion 414. The octal PHY portion 414 may comprise a 10/100/1000 Base T 8-port Ethernet (or other network) transceiver circuit. The network port portion 416 may comprise an Ethernet (or other network) transformer and associated CAT-5E receptacle (or other cable type receptacle) for receiving a network cable 418, such as the network cable 208 (shown in FIG. 2).

The VDSL module 408 is also connected to the main bus 404 by way of an octal PHY unit 420, which may be the same unit as the octal PHY portion 414 or a different octal PHY unit. The VDSL module 408 comprises a physical interface portion (PHY) 422 electrically connected to the octal PHY unit 420, a VDSL control 424 electrically connected to the physical interface portion 422, a VDSL analog front end unit 426 electrically connected to the VDSL control 424, and a VDSL port unit 428 electrically connected to the VDSL analog front end unit 426. The physical interface portion 422 acts as a physical and electrical interface with the octal PHY unit 420, e.g., the physical interface portion 422 may comprise a port and related support circuity. The VDSL analog front end unit 426 is configured for transceiving modulated network data (e.g., sending and receiving modulated data) over the power supply conductor 112, and may include one or more of the following: analog filters, line drivers, analog-to-digital and digital-to-analog converters, and related support circuitry (e.g., capacitors). The VDSL control 424 is configured for converting and/or processing network data for modulation and de-modulation, and may include a microprocessor unit, ATM (asynchronous transfer mode) and IP (Internet Protocol) interfaces, and digital signal processing circuitry/functionality. The VDSL port unit 428 provides a physical and electrical connection to the power supply conductor 112, and may include transformer circuitry, circuit protection functionality, and a port or other attachment or connection mechanism for connecting the VDSL module 408 to the power supply conductor 112. Overall operation of the router transceiver unit 104 shown in FIG. 4 may be similar to what is described in relation to FIGS. 1, 2, and 3.

FIG. 9 is a schematic diagram of another embodiment of a router transceiver unit 900. The router transceiver unit 900 may be similar to the router transceiver unit 104 shown in FIG. 1. For example, the router transceiver unit 900 may be coupled with the power supply conductor 112, the electronic component 102, and/or the wayside device 106 to transmit network data from the electronic component 102 and/or the wayside device 106 through the power supply conductor 112 and/or receive network data through the power supply conductor 112.

In the illustrated embodiment, the router transceiver unit 900 includes an adapter 902 and a communication unit 904 operably coupled with each other to permit communication of data between the adapter 902 and the communication unit 904. The adapter 902 is operably coupled with the electronic component 102 of a wayside device 106. The electronic component 102 may generate data related to the wayside device 106. For example, the electronic component 102 may create data that represents or includes measurements obtained from a sensor, diagnostic information of the wayside device 106, alarm information of the wayside device 106, a status of the wayside device 106 (e.g., a current state of a rail signal device), or a condition of the wayside device 106 (e.g., in need of repair or maintenance, functioning without need for repair or maintenance, and the like). The data may be non-network data, such as analog data, or a non-digital signal. For example, the electronic component 102 may be a non-network enabled device that transmits data other than network data (e.g., other than packetized data) to the adapter 902.

The electronic component 102 communicates the data as electric signals to the adapter 902. Alternatively, the electronic component 102 may be network enabled such that the electronic component 102 transmits the data as network data (e.g., packet data) over an Ethernet line or connection between the electronic component 102 and the adapter 902.

The communication unit 904 is conductively coupled to the power supply conductor 112 that supplies electric current to the wayside device 106 and/or another electronic apparatus other than the electronic component 102 to power the electronic component 102 and/or electronic apparatus. The power supply conductor 112 may supply the electric current from a remote source, such as a source that is disposed outside of the router transceiver unit 900, the electronic component 102, and/or the wayside device 106. In one embodiment, the power supply conductor 112 supplies electric current from a power sub-station or a power grid that is disposed several miles (e.g., 5, 10, 15, 20, 25, or 50 miles or farther) away from the router transceiver unit 900.

The communication unit 904 receives the non-network data as the electric signals from the adapter 902 and converts the non-network data into network data (e.g., “converted network data”). For example, the communication unit 904 may convert analog electric signals received from the adapter 902 to modulated network data. The communication unit 904 communicates the modulated network data over the power supply conductor 112 to another location, such as another router transceiver unit 900 coupled with another wayside device 106, a node 120 (shown in FIG. 1), and/or another location. In one embodiment, the communication unit 904 communicates the converted network data to a remote location, such as a location that is at least several miles away.

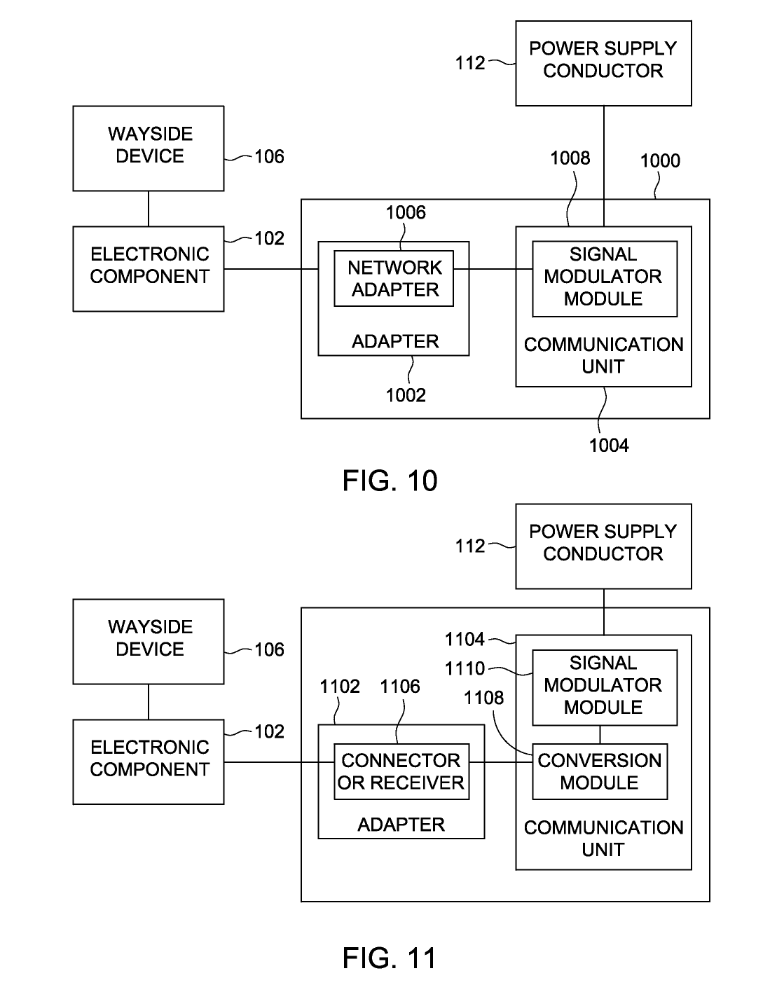

FIG. 10 is a schematic diagram of another embodiment of a router transceiver unit 1000. The router transceiver unit 1000 may be similar to the router transceiver unit 104 shown in FIG. 1. For example, the router transceiver unit 1000 may be coupled with the power supply conductor 112, the electronic component 102, and/or the wayside device 106 to transmit network data from the wayside device 106 and/or from the electronic component 102 through the power supply conductor 112 and/or receive network data through the power supply conductor 112.

The router transceiver unit 1000 includes an adapter 1002 and a communication unit 1004 operably coupled with each other. The adapter 1002 is operably coupled with the electronic component 102 of the wayside device 106. The adapter 1002 receives data as electrical signals from the electronic component 102. In the illustrated embodiment, the adapter 1002 includes a network adapter 1006 that receives network data from the electronic component 102.

The communication unit 1004 is conductively coupled to the power supply conductor 112 that supplies electric current to the wayside device 106 to power the electronic component 102 and/or another electronic apparatus other than the electronic component 102. The power supply conductor 112 may supply the current from a remote source, such as a source that is located several miles away. The communication unit 1004 converts the network data received from the electronic component 102 via the network adapter 1006 of the adapter 1002 to modulated network data. The communication unit 1004 transmits the modulated network data over the power supply conductor 112 to another location, such as another wayside device 106 and/or another remote location.

In one embodiment, the communication unit 1004 includes a signal modulator module 1008 operably coupled with the network adapter 1006 of the adapter 1002. The signal modulator module 1008 receives the network data from the network adapter 1006 and converts the network data (e.g., such as by modulating the network data) to converted network data (e.g., such as modulated network data) for transmission over the power supply conductor 112.

FIG. 11 is a schematic diagram of another embodiment of a router transceiver unit 1100. The router transceiver unit 1100 may be similar to the router transceiver unit 104 shown in FIG. 1. For example, the router transceiver unit 1100 may be coupled with the power supply conductor 112, the electronic component 102, and/or the wayside device 106 to transmit network data from the wayside device 106 and/or the electronic component 102 through the power supply conductor 112 and/or receive network data through the power supply conductor 112.

The router transceiver unit 1100 includes an adapter 1102 and a communication unit 1104 operably coupled with each other. The adapter 1102 is operably coupled with the electronic component 102 of the wayside device 106. The adapter 1102 receives data as electrical signals from the electronic component 102. The adapter 1102 may include an electrical interface component 1106 (“Connector or Receiver”) that interfaces with the electronic component 102. The interface component 1106 may include an electrical connector that mechanically couples with the electronic component 102 to receive electrical signals that include data (e.g., analog data and/or network data) obtained or generated by the electronic component 102. Alternatively or additionally, the interface component 1106 may include a wireless transceiver that wirelessly communicates with the electronic component. For example, the interface component may receive data from the electronic component 102 via a wireless communication link.

In one embodiment, the interface component 1106 includes one or more electronic receiver elements that perform signal processing of the electric signals received from the electronic component 102. For example, the interface component 1106 may include one or more devices such as buffers, level shifters, demodulators, amplifiers, filters, and the like, that are used to process electrical signals received from the electronic component 102 and that include the data from the electronic component 102.

The communication unit 1104 is conductively coupled to the power supply conductor 112 that supplies electric current to the electronic component 102 and/or the wayside device 106 to power the electronic component 102, the wayside device 106, and/or an electronic apparatus other than the electronic component 102. As described above, the power supply conductor 112 may supply electric current from a remote source, such as a source that is located several miles away.

The communication unit 1104 may convert the data received from the electronic component 102 via the adapter 1102 to modulated network data and to transmit the modulated network data over the power supply conductor 112. The communication unit 1104 may transmit the modulated network data to a remote location, such as another router transceiver unit 1100 and/or node 120 (shown in FIG. 1) disposed several miles away.

In the illustrated embodiment, the communication unit 1104 includes a conversion module 1108 and a signal modulator module 1110. The conversion module 1108 is operably coupled to the adapter 1102 to receive the data from the electronic component 102 via the adapter 1102. The conversion module 1108 converts the received data to network data. For example, the conversion module 1108 may receive non-network data (e.g., analog data) from the adapter 1102 and reformat the data into packet form, including headers, footers, and/or data conversion from an analog format to a digital format, to form the network data.

The signal modulator module 1110 receives the network data from the conversion module 1108 and may convert the network data, such as by modulating the network data, into modulated network data for transmission over the power supply conductor 112. The communication unit 1104 may then transmit the modulated network data through the power supply conductor 112.

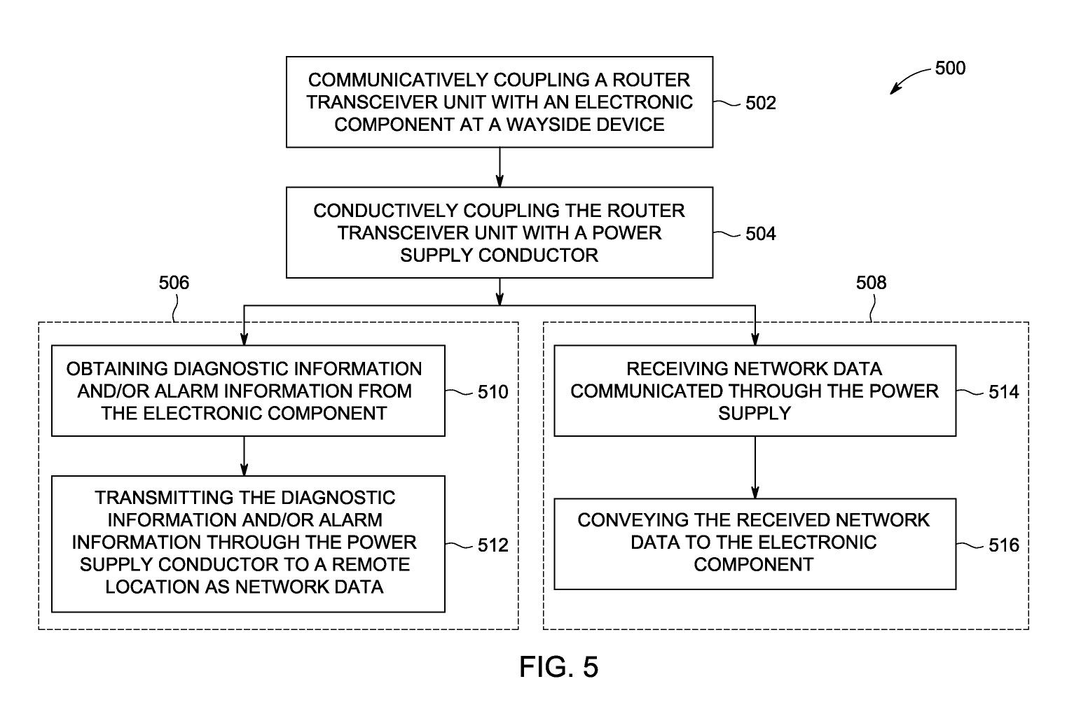

FIG. 5 is a flowchart of a method 500 for communicating network data. The method 500 may be used in conjunction with one or more embodiments of the communication system 100 shown in FIG. 1. For example, the method 500 may be used to communicate network data with and/or between the router transceiver units 104 (shown in FIG. 1) coupled with the electronic components 102 (shown in FIG. 1) of the wayside devices 106 (shown in FIG. 1) through the power supply conductors 112 (shown in FIG. 1).

At 502, a router transceiver unit is communicatively coupled with an electronic component of a wayside device. As described above, the router transceiver unit 104 (shown in FIG. 1) can be coupled with the electronic component 102 (shown in FIG. 1) using one or more wired and/or wireless communication links.

At 504, the router transceiver unit is conductively coupled with a power supply conductor. For example, the router transceiver unit 104 (shown in FIG. 1) may be conductively coupled with the power supply conductor 112 (shown in FIG. 1) that also supplies electric current to the electronic component 102 (shown in FIG. 1) and/or one or more other electronic apparatuses 116, 118 (shown in FIG. 1).

The method 500 includes two legs that include a transmission leg 506 and a receiving leg 508. One or more of the operations described in connection with each of the legs 506, 508 may be performed at different time periods, concurrently, or simultaneously. With respect to the transmission leg 506, at 510, diagnostic information and/or alarm information is obtained from the electronic component to which the router transceiver unit is coupled. For example, the electronic component 102 (shown in FIG. 1) may obtain diagnostic and/or alarm information related to the rail vehicle 108 (shown in FIG. 1) and/or the route 110 (shown in FIG. 1). This diagnostic and/or alarm information is communicated to the router transceiver unit 104 (shown in FIG. 1).

At 512, the router transceiver unit transmits the diagnostic information and/or alarm information through one or more of the power supply conductors as network data. For example, the router transceiver unit 104 (shown in FIG. 1) may communicate network data that includes diagnostic information, alarm information, or another type of information to a remote location, such as the node 120 (shown in FIG. 1) and/or another router transceiver unit 104.

With respect to the receiving leg 508, at 514, the router transceiver unit receives network data through the power supply conductor. For example, the router transceiver unit 104 (shown in FIG. 1) may receive control information used to control the rail vehicle 108 (show in FIG. 1), status information, diagnostic information, alarm information, or another type of information. The router transceiver unit 104 may receive the information as network data that is communicated in packets through one or more of the power supply conductors 112 (shown in FIG. 1).

At 516, the router transceiver unit conveys the information of the received network data to the electronic component coupled with the router transceiver unit. For example, the router transceiver unit 104 (shown in FIG. 1) may convey control information that directs the electronic component 102 (shown in FIG. 1) to change a color of a light that is illuminated at the wayside device 106 (shown in FIG. 1), to change a position of a switch of the wayside device 106, or to otherwise change a condition of the electronic component 102 and/or the wayside device 106.

In one or more of the embodiments set forth herein, the network data transmitted over the power supply conductor 112 may additionally or alternatively be “high bandwidth” data, such as data transmitted at average rates of 10 Mbit/sec or greater. In one aspect, the data is high bandwidth data. In another aspect, the data is network data. In another aspect, the data is both high bandwidth data and network data, referred to herein as “high bandwidth network data,” meaning data that is packaged in packet form as data packets and transmitted over the power supply conductor 112 at average rates of 10 Mbit/sec or greater. In contrast, “low bandwidth” data is data transmitted at average rages of less than 10 Mbit/sec, and “very low bandwidth” data (a type of low bandwidth data) is data transmitted at average rates of 1200 bits/sec or less.

In one embodiment, a communication system is provided. The system includes an electronic component located at a wayside device positioned along a route of a rail vehicle and a router transceiver unit operably coupled to the electronic component. The router transceiver unit is conductively coupled to a power supply conductor that supplies electric current to power at least one of the electronic component of the wayside device or an electronic apparatus other than the electronic component. The router transceiver unit is configured to communicate network data with a remote location through the power supply conductor.

In another aspect, the power supply conductor is a pre-existing power supply conductor

In another aspect, the power supply conductor includes at least one of a power distribution cable, an aerial pole line, or a cable conductively coupled with a commercial power grid.

In another aspect, the power supply conductor, to which the router transceiver unit is conductively coupled, supplies the electric current to the electronic component and a plurality of other electronic components disposed along the route of the rail vehicle.

In another aspect, the electronic component is coupled with the pre-existing power supply conductor to receive the electric current prior (e.g., in a temporal sense such as prior in time) to the router transceiver unit being conductively coupled to the power line.

In another aspect, the wayside device includes at least one of a road crossing warning system, a track switch, a positive train control device, a rail signal device, or a sensor that detects a condition of at least one of the route or the rail vehicle.

In another aspect, the electronic component is configured to obtain at least one of diagnostic information or alarm information related to the wayside device and the router transceiver unit is configured to transmit the at least one of the diagnostic information or the alarm information to the remote location.

In another aspect, the power supply conductor is a conductor other than a running rail of a track, a powered third rail of the track, or an overhead catenary.

In another aspect, the router transceiver unit is configured to communicate the network data as high bandwidth network data.

In another aspect, the electronic component is network enabled and is configured to communicate the network data to the router transceiver unit and the router transceiver unit is configured to communicate the network data through the power supply conductor.

In another aspect, the electronic component is non-network enabled and is configured to communicate non-network data obtained or created by the electronic component to the router transceiver unit. The router transceiver unit may be configured to convert the non-network data into the network data for communication of the network data through the power supply conductor.

In another embodiment, a method of communicating network data is provided. The method includes communicatively coupling a router transceiver unit with an electronic component located at a wayside device positioned along a route of a rail vehicle and conductively coupling the router transceiver unit to a power supply conductor used to supply electric current to power at least one of the electronic component of the wayside device or an electronic apparatus other than the electronic component. The router transceiver unit is configured to communicate network data with a remote location through the power supply conductor.

In another aspect, the power supply conductor is a pre-existing power supply conductor.

In another aspect, the conductively coupling step includes coupling the router transceiver unit to the power supply conductor after coupling the electronic component with the power supply conductor.

In another aspect, the power supply conductor includes at least one of a power distribution cable, an aerial pole line, or a cable conductively coupled with a commercial power grid.

In another aspect, the method also includes conductively coupling a plurality of second router transceiver units to the power supply conductor, each at a respective different wayside device positioned along the route, where each of the second router transceiver units is configured to communicate network data with the remote location through the power supply conductor.

In another aspect, the communicatively coupling step includes coupling the router transceiver unit to the electronic component of the wayside device that includes at least one of a road crossing warning system, a track switch, a positive train control device, a rail signal device, or a sensor that detects a condition of at least one of the route or the rail vehicle.

In another aspect, the method also includes configuring the electronic component to obtain at least one of diagnostic information or alarm information related to the wayside device and to transmit the at least one of the diagnostic information or the alarm information to the remote location.

In another aspect, the power supply conductor is a conductor other than a running rail of a track, a powered third rail of the track, or an overhead catenary.

In another embodiment, a communication system is provided. The system includes plural electronic components respectively located at a plurality of wayside devices positioned at different locations along a route of a rail vehicle and plural router transceiver units respectively operably coupled to the electronic components. The router transceiver units are conductively coupled to one or more power supply conductors that supply electric current to power at least one of the electronic components of the wayside devices or one or more electronic apparatuses other than the electronic components. The system also includes a common node conductively coupled with the router transceiver units by the one or more power supply conductors. The common node is configured to communicate network data with the router transceiver units through the one or more power supply conductors.

In another aspect, the one or more power supply conductors include one or more power distribution cables, aerial pole lines, or cables conductively coupled with a commercial power grid.

In another aspect, the wayside devices each include at least one of a road crossing warning system, a track switch, a positive train control device, a rail signal device, or a sensor that detects a condition of at least one of the route or the rail vehicle.

In another aspect, one or more of the electronic components is configured to obtain at least one of diagnostic information or alarm information related to one or more of the wayside devices and transmit the at least one of the diagnostic information or the alarm information to the common node.

In another aspect, the one or more power supply conductors includes conductors other than a running rail of a track, a powered third rail of the track, or an overhead catenary.

In another embodiment, a communication method is provided. The method includes, at a wayside device positioned along a route of a rail vehicle, automatically generating first data relating to operation of the wayside device and converting the first data into modulated network data for transmission over a power supply conductor that supplies electric current for powering at least one of an electronic component of the wayside device or an electronic apparatus other than the electronic component. The method also includes transmitting the modulated network data over the power supply conductor to a remote location.

In another aspect, the step of converting the first data into the modulated network data includes, if the first data is non-network data, converting the first data into network data and modulating the network data into the modulated network data.

In another embodiment, a communication method is provided. The method includes, over one or more power supply conductors that supply electric current for electrically powering at least one of plural wayside devices positioned along one or more rail vehicle routes or an electrical apparatus other than the plural wayside devices, respectively receiving plural first signals from the plural wayside devices, each first signal including respective network data. The method also includes demodulating the plural first signals into respective second signals, the second signals comprising at least the respective network data and converting the second signals into respective third signals for transmission over an Ethernet line, the Internet, or other network. The method further includes transmitting the third signals over the Ethernet line, the Internet, or the other network to one or more remote locations.

In another aspect, one of the plural first signals is received over a first one of the power supply conductors and another of the plural first signals is received over a second, different one of the power supply conductors.

In another embodiment, a communication system is provided. The system includes a router transceiver unit comprising an adapter and a communication unit operably coupled to the communication unit. The adapter is configured to be operably coupled with an electronic component of a wayside device, for receiving first data from the electronic component. The communication unit is configured to be conductively coupled to a power supply conductor that supplies electric current to power the electronic component or an electronic apparatus other than the electronic component, and wherein the communication unit is further configured to convert the first data to modulated network data and to transmit the modulated network data over the power supply conductor to a remote location.

In another aspect, the adapter comprises a network adapter for receiving the first data as network data from the electronic component. The communication unit includes a signal modulator module for modulating the network data to the modulated network data for transmission over the power supply conductor.

In another aspect, the adapter comprises a connector for connecting the router transceiver unit to the electronic component, and the communication unit comprises a conversion module operably coupled to the connector and a signal modulator module operably coupled with the conversion module. The conversion module is configured for conversion of the first data to the network data. The signal modulator module is configured for modulation of the network data to the modulated network data.

In another embodiment, a method for communicating with a wayside signal device is provided. The method includes transceiving network data at a wayside signal device located adjacent to a route of a rail vehicle, where the network data is transceived at the wayside signal device over a pre-existing electrical power line used to provide the wayside signal device with electrical power and/or that lies proximate to the wayside signal device.

In another aspect, the network data is received over the pre-existing electrical power line from an entity remote from the wayside signal device, and the network data is used to control the wayside signal device.

In another aspect, the network data is transmitted over the pre-existing electrical power line to an entity remote from the wayside signal device, and the network data includes information relating to a present operational mode of the wayside signal device.

In another aspect, the network data is received at the wayside signal device over the pre-existing electrical power line as modulated network data. The method may also include de-modulating the modulated network data for use by the wayside signal device and/or a network device operably coupled to the wayside signal device.

In another aspect, the network data is high bandwidth network data.

In another aspect, the wayside signal device is a mechanical, non-electrical wayside signal device and the pre-existing electrical power line lies proximate to the wayside signal device but does not provide electrical power to the wayside signal device. The network data may be transceived at a wayside signal device by a network device operably coupled to the wayside signal device.

In another aspect, the network data is transmitted over the pre-existing electrical power line to an entity remote from the wayside signal device, and/or the network data is received over the pre-existing electrical power line from the remote entity. The method may include transmitting and/or receiving the network data over the pre-existing electrical power line as the only communication between the wayside signal device and remote locations.

In another aspect, the network data is transmitted over the pre-existing electrical power line to an entity remote from the wayside signal device, and/or the network data is received over the pre-existing electrical power line from the remote entity. The method may also include transmitting signals between the wayside signal device and the remote entity over an electrical conductor that is not part of any pre-existing electrical power lines for providing electrical power to the wayside signal device.

In another embodiment, another method for communicating with a wayside signal device is provided. The method includes receiving first high bandwidth network data at a wayside signal device located adjacent to a route of a rail vehicle. The network data is received at the wayside signal device over a pre-existing electrical power line that provides the wayside signal device with electrical power. The method also includes controlling the wayside signal device based on the first high bandwidth network data.

In another embodiment, another communication system is provided. The system includes a router transceiver unit operably coupled to an electronic component located at a wayside signal device positioned adjacent to a route of a rail vehicle. The router transceiver unit is electrically coupled to a pre-existing electrical power line used to provide electrical power to the wayside signal device and/or that lies proximate to the wayside signal device. The router transceiver unit is configured to transmit and/or receive network data over the electrical power line. The network data originates at a location remote to the wayside signal device and is received at the wayside signal device and/or the network data comprising information generated by the electronic component and transmitted to a remote location.

In another aspect, the network data is high bandwidth network data.

In another embodiment, another communication system is provided. The system includes a computer network in a rail transit system. The computer network comprises a respective electronic component positioned at each of at least two of a plurality of wayside signal devices. Each wayside signal device is located adjacent to a route of a rail vehicle. A pre-existing electrical power grid supplies electrical power to the at least two of the plurality of wayside signal devices. The electronic components are configured to communicate by transmitting network data over the electrical power grid. The network data originates at one of the electronic components and being addressed to another of the electronic components or to another component at a remote location.

In another aspect, the network is an Ethernet network.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person skilled in the art to practice the embodiments of invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present invention will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described system and method for communicating with a wayside device, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A communication system comprising:
an electronic component located at a wayside device positioned along a route of a rail vehicle; and
a router transceiver unit operably coupled to the electronic component, the router transceiver unit conductively coupled to a power supply conductor that supplies electric current to power at least one of the electronic component of the wayside device or an electronic apparatus other than the electronic component, wherein the router transceiver unit is configured to communicate network data with a remote location through the power supply conductor.

2. The system of claim 1, wherein the power supply conductor is a pre-existing power supply conductor

3. The system of claim 1, wherein the power supply conductor includes at least one of a power distribution cable, an aerial pole line, or a cable conductively coupled with a commercial power grid.

4. The system of claim 1, wherein the power supply conductor, to which the router transceiver unit is conductively coupled, supplies the electric current to the electronic component and a plurality of other electronic components disposed along the route of the rail vehicle.

5. The system of claim 1, wherein the wayside device includes at least one of a road crossing warning system, a track switch, a positive train control device, a rail signal device, or a sensor that detects a condition of at least one of the route or the rail vehicle.

6. The system of claim 1, wherein the electronic component is configured to obtain at least one of diagnostic information or alarm information related to the wayside device and the router transceiver unit is configured to transmit the at least one of the diagnostic information or the alarm information to the remote location.

7. The system of claim 1, wherein the power supply conductor is a conductor other than a running rail of a track, a powered third rail of the track, or an overhead catenary.

8. The system of claim 1, wherein the router transceiver unit is configured to communicate the network data as high bandwidth network data.

9. The system of claim 1, wherein the electronic component is network enabled and is configured to communicate the network data to the router transceiver unit and the router transceiver unit is configured to communicate the network data through the power supply conductor.

10. The system of claim 1, wherein the electronic component is non-network enabled and is configured to communicate non-network data obtained or created by the electronic component to the router transceiver unit, and the router transceiver unit is configured to convert the non-network data into the network data for communication of the network data through the power supply conductor.

11. A method of communicating network data, the method comprising:
communicatively coupling a router transceiver unit with an electronic component located at a wayside device positioned along a route of a rail vehicle; and
conductively coupling the router transceiver unit to a power supply conductor used to supply electric current to power at least one of the electronic component of the wayside device or an electronic apparatus other than the electronic component, wherein the router transceiver unit is configured to communicate network data with a remote location through the power supply conductor.

12. The method of claim 11, wherein the power supply conductor is a pre-existing power supply conductor.

13. The method of claim 11, wherein the conductively coupling step includes coupling the router transceiver unit to the power supply conductor after coupling the electronic component with the power supply conductor.

14. The method of claim 11, wherein the power supply conductor includes at least one of a power distribution cable, an aerial pole line, or a cable conductively coupled with a commercial power grid.

15. The method of claim 11, further comprising conductively coupling a plurality of second router transceiver units to the power supply conductor, each at a respective different wayside device positioned along the route, wherein each of the second router transceiver units is configured to communicate network data with the remote location through the power supply conductor.

16. The method of claim 11, wherein the communicatively coupling step includes coupling the router transceiver unit to the electronic component of the wayside device that includes at least one of a road crossing warning system, a track switch, a positive train control device, a rail signal device, or a sensor that detects a condition of at least one of the route or the rail vehicle.

17. The method of claim 11, further comprising configuring the electronic component to obtain at least one of diagnostic information or alarm information related to the wayside device and to transmit the at least one of the diagnostic information or the alarm information to the remote location.

18. The method of claim 11, wherein the power supply conductor is a conductor other than a running rail of a track, a powered third rail of the track, or an overhead catenary.

19. A communication system comprising:
plural electronic components respectively located at a plurality of wayside devices positioned at different locations along a route of a rail vehicle;
plural router transceiver units respectively operably coupled to the electronic components, the router transceiver units conductively coupled to one or more power supply conductors that supply electric current to power at least one of the electronic components of the wayside devices or one or more electronic apparatuses other than the electronic components; and
a common node conductively coupled with the router transceiver units by the one or more power supply conductors, wherein the common node is configured to communicate network data with the router transceiver units through the one or more power supply conductors.

20. The system of claim 19, wherein the one or more power supply conductors include one or more power distribution cables, aerial pole lines, or cables conductively coupled with a commercial power grid.

21. The system of claim 19, wherein the wayside devices each include at least one of a road crossing warning system, a track switch, a positive train control device, a rail signal device, or a sensor that detects a condition of at least one of the route or the rail vehicle.

22. The system of claim 19, wherein one or more of the electronic components is configured to obtain at least one of diagnostic information or alarm information related to one or more of the wayside devices and transmit the at least one of the diagnostic information or the alarm information to the common node.

23. The system of claim 19, wherein the one or more power supply conductors includes conductors other than a running rail of a track, a powered third rail of the track, or an overhead catenary.

24. A communication method comprising, at a wayside device positioned along a route of a rail vehicle:
automatically generating first data relating to operation of the wayside device;
converting the first data into modulated network data for transmission over a power supply conductor that supplies electric current for powering at least one of an electronic component of the wayside device or an electronic apparatus other than the electronic component; and
transmitting the modulated network data over the power supply conductor to a remote location.

25. The method of claim 24, wherein the step of converting the first data into the modulated network data comprises, if the first data is non-network data, converting the first data into network data and modulating the network data into the modulated network data.

26. A communication method comprising:
over one or more power supply conductors that supply electric current for electrically powering at least one of plural wayside devices positioned along one or more rail vehicle routes or an electrical apparatus other than the plural wayside devices, respectively receiving plural first signals from the plural wayside devices, each first signal including respective network data;
demodulating the plural first signals into respective second signals, the second signals comprising at least the respective network data;
converting the second signals into respective third signals for transmission over an Ethernet line, the Internet, or other network; and
transmitting the third signals over the Ethernet line, the Internet, or the other network to one or more remote locations.

27. The method of claim 26, wherein one of the plural first signals is received over a first one of the power supply conductors and another of the plural first signals is received over a second, different one of the power supply conductors.

28. A communication system comprising:
a router transceiver unit comprising an adapter and a communication unit operably coupled to the communication unit;
wherein the adapter is configured to be operably coupled with an electronic component of a wayside device, for receiving first data from the electronic component; and
wherein the communication unit is configured to be conductively coupled to a power supply conductor that supplies electric current to power the electronic component or an electronic apparatus other than the electronic component, and wherein the communication unit is further configured to convert the first data to modulated network data and to transmit the modulated network data over the power supply conductor to a remote location.

29. The system of claim 28, wherein the adapter comprises a network adapter for receiving the first data as network data from the electronic component, and the communication unit comprises a signal modulator module for modulating the network data to the modulated network data for transmission over the power supply conductor.

30. The system of claim 28, wherein the adapter comprises a connector for connecting the router transceiver unit to the electronic component, and the communication unit comprises a conversion module operably coupled to the connector and a signal modulator module operably coupled with the conversion module, the conversion module configured for conversion of the first data to the network data, and the signal modulator module configured for modulation of the network data to the modulated network data.
